(19) United States
(12) Patent Application Publication
(10) Pub. No.: US 2018/0263328 A1
(43) Pub. Date: Sep. 20, 2018

(54) Triboelectric Generator Electrode, Manufacturing Methods Thereof, and Light Emitting Shoe

(71) Applicant: Nazhiyuan Technology (Tangshan), LLC, Tangshan (CN)

(72) Inventors: Shan WANG, Tangshan (CN); Xiaoyue FU, Tangshan (CN); Xiaoxiong WANG, Tangshan (CN); Shun FENG, Tangshan (CN); Hao ZHAO, Tangshan (CN); Chi CHENG, Tangshan (CN); Ying ZHAO, Tangshan (CN)

(21) Appl. No.: 15/756,796

(22) PCT Filed: Sep. 9, 2016
(86) PCT No.: PCT/CN2016/098522

§ 371 Date: Mar. 1, 2018

(30) Foreign Application Priority Data
Sep. 11, 2015 (CN) 201510577561.2
May 20, 2016 (CN) 201620467442.1

(51) Int. Cl. A43B 3/00; A43B 3/30; H02N 1/04

(52) U.S. Cl. CPC A43B 3/001; A43B 3/0015; A43B 5/00; H02N 1/04; A43B 3/30

(57) ABSTRACT

Disclosed here are a triboelectric generator electrode, manufacturing methods thereof, and light emitting shoes. The triboelectric generator electrode includes a porous electrode layer and a high molecular polymer insulating layer, and the porous electrode layer and the high molecular polymer insulating layer are mutually embedded to form an embedded body. The manufacturing method of the triboelectric generator electrode includes the following steps: (1) brushing a high molecular polymer insulating coating on the surface of a template having a microstructure, and carrying out a degassing treatment; (2) cutting a porous electrode layer with a smooth surface into a target size; (3) fitting the porous electrode layer to the surface of the high molecular polymer insulating coating, and carrying out a curing treatment; and (4) taking a high molecular polymer insulating coating/porous electrode layer composite film from the surface of the template.

### FIELD OF THE INVENTION

The present invention relates to the field of electronic circuits, and in particular to a triboelectric generator electrode, manufacturing methods thereof, and light emitting shoes.

### BACKGROUND OF THE INVENTION

Energy collection and conversion devices constructed by using the nanotechnology have played a key role in self-powered nano-systems and have drawn increasing attention due to their environmental protection, energy saving and self-driven properties. Since the piezoelectric nano-generator developed by the research group of professor Wang Zhonglin converted the mechanical energy into electric energy for the first time, nano-generators of different structures and materials based on piezoelectricity and triboelectricity have come out one after another. With the maturity and the improvement of the nano-generator technology, the nano-generators are applied to products in various fields more and more widely.

In the existing triboelectric generator, an electrode layer and a triboelectric layer are arranged in a laminated manner, that is, the two layers have planar structure, and a sputtered metal thin layer, an adhesion conductive layer or a brushed conductive layer or the like is generally adopted, so that the contact between the manufactured triboelectric generator electrode layer and the triboelectric layer is not strong. In addition, since the triboelectric layer and the electrode layer of the triboelectric generator are in planar contact, the power generation efficiency is relatively low. Therefore, there is a need to find a novel triboelectric generator electrode arrangement manner so as to enhance the fastness of the electrode and improve the power generation performance of the triboelectric generator.

In the field of product applications, with the development of science and technology, light emitting shoes as highly interesting high-tech products have gradually come into the lives of people. In particular, many children light emitting shoes not only bring great interest to children, but also can guide children in the night, so that the children can be aware of changes in their surroundings in time and actively guard against dangerous situations; meanwhile, in the dark, the light emitting shoes can be timely discovered by drivers of vehicles, so as to avoid traffic accident. Although the light emitting shoes have many advantages, however, the existing light emitting shoes are mostly powered by batteries, the light emitting shoes cannot continue to emit light after the energy of the batteries are used up, thereby causing great restrictions to the light emitting time of the light emitting shoes. Moreover, the replacement of the batteries will not only bring trouble to use, but also cause damage to the shoes themselves, thereby affecting later wear. In addition, usually during walking, soles generate pressure to the pavement via the shoes, resulting in mechanical energy. The mechanical energy produced by an adult during the walking through the shoes is considerable, but the current light emitting shoes do not utilize the mechanical energy, which is just wasted.

### SUMMARY OF THE INVENTION

One objective of the present invention is to overcome the shortcomings of unsecured contact of the electrode layer with the triboelectric layer of the existing triboelectric generator and low power generation efficiency, and to provide an electrode of a triboelectric generator, so that the fastness of the electrode can be enhanced, and the power generation performance and the flexibility of the triboelectric generator can be improved.

Another objective of the present invention is to provide a light emitting shoe in view of the shortcomings in the prior art, in order to solve the problem in the prior art that the light emitting shoe needs to be powered by a battery, thereby wasting energy, polluting the environment, having a complicated structure and manufacturing process and a high cost.

In order to achieve the above objective, the present invention provides a triboelectric generator electrode, including a porous electrode layer and a high molecular polymer insulating layer, wherein the porous electrode layer and the high molecular polymer insulating layer are mutually embedded to form an embedded body.

The present invention further provides a manufacturing method of a triboelectric generator electrode, the method including the following steps:
(1) brushing a first high molecular polymer insulating coating on the surface of a template having a microstructure, and carrying out a degassing treatment;
(2) cutting a porous electrode layer with a smooth surface into a target size;
(3) fitting the porous electrode layer to the surface of the first high molecular polymer insulating coating, and carrying out a curing treatment; and
(4) taking a first high molecular polymer insulating coating/porous electrode layer composite film from the surface of the template.

Compared with the electrode arrangement of the existing triboelectric generator, the electrode arrangement manner of the triboelectric generator in the present invention has the following advantages:
1) The electrode arrangement manner of the triboelectric generator in the present invention enhances the fastness of the electrode, so that it is not liable to fall off.
2) The electrode arrangement manner of the triboelectric generator in the present invention improves the power generation performance of the triboelectric generator.
3) The electrode arrangement manner of the triboelectric generator in the present invention improves the flexibility of the triboelectric generator.

In order to achieve the other objective mentioned above, the present invention provides a light emitting shoe, including a sole and a vamp, and further including: a triboelectric power generation module, a rectifier circuit module and a display module; wherein the triboelectric power generation module and the rectifier circuit module are located at the sole, and the display module is located on the sole and/or the vamp; the triboelectric power generation module includes at least one triboelectric generator for converting mechanical energy into electric energy; wherein the triboelectric generator includes the triboelectric generator electrode mentioned above or the triboelectric generator electrode manufactured by the manufacturing method of the triboelectric generator electrode mentioned above; the rectifier circuit module includes at least one rectifier bridge connected with the triboelectric power generation module and used for rectifying the electric energy output by the triboelectric power generation module; and the display module is connected with the rectifier circuit module and is used for receiving the electric energy output by the rectifier circuit module to achieve light emitting display of the display module.

According to the light emitting shoe provided by the present invention, the external force acting on the sole during walking is converted by the triboelectric power generation module into electric energy, which is then converted by the rectifier circuit module to provide electric energy for the display module on the light emitting shoe, so that the display module emits light. According to the light emitting shoe provided by the present invention, the mechanical energy during walking of a human body is reasonably utilized by the triboelectric power generation module, thereby omitting the use of the battery, which avoids the inconvenience that the light emitting shoe cannot emit light after the energy of the battery is used up and then the battery has to be replaced; furthermore, as the use of the battery is avoided, the energy is saved, and the environment is protected; and moreover, the triboelectric generator of the light emitting shoe provided by the present invention includes the triboelectric generator electrode mentioned above, thereby enhancing the fastness of the triboelectric generator and improving the power generation performance of the triboelectric generator, accordingly, the durability of the light emitting shoe is enhanced, and the performance of the light emitting shoe is also improved. In addition, the light emitting shoe provided by the present invention is simple in structure and manufacturing process and low in cost, thereby being suitable for large-scale industrialized production.

### BRIEF DESCRIPTION OF THE DRAWINGS

FIG. 1 is a schematic diagram of an overall structure of an embodiment of a light emitting shoe provided by the present invention;

FIG. 2 is a schematic diagram of a module structure of an embodiment of a light emitting shoe provided by the present invention;

FIGS. 3a-3k are schematic diagrams of a connecting structure of modules in an embodiment of a light emitting shoe provided by the present invention;

FIG. 4 is a schematic position diagram of an embodiment of a light emitting shoe provided by the present invention;

FIGS. 5a-5b are structural schematic diagrams of a common-electrode-configuration triboelectric generator in a light emitting shoe provided by the present invention;

FIG. 6 is a circuit diagram of another embodiment of a light emitting shoe provided by the present invention;

FIG. 7 is a circuit diagram of yet another embodiment of a light emitting shoe provided by the present invention;

FIG. 8 is a structural schematic diagram of a specific embodiment of a triboelectric generator electrode in the present invention;

FIG. 9 is a structural schematic diagram of another specific embodiment of a triboelectric generator electrode in the present invention;

FIG. 10 is a section view of an embedded body of a triboelectric generator electrode in the present invention; and

FIG. 11 is a flowchart of a manufacturing method of a triboelectric generator electrode in the present invention.

### PREFERRED EMBODIMENTS OF THE INVENTION

In order to fully understand the objectives, features and effects of the present invention, the present invention will be described in detail by virtue of the following specific embodiments, but the present invention is not limited thereto.

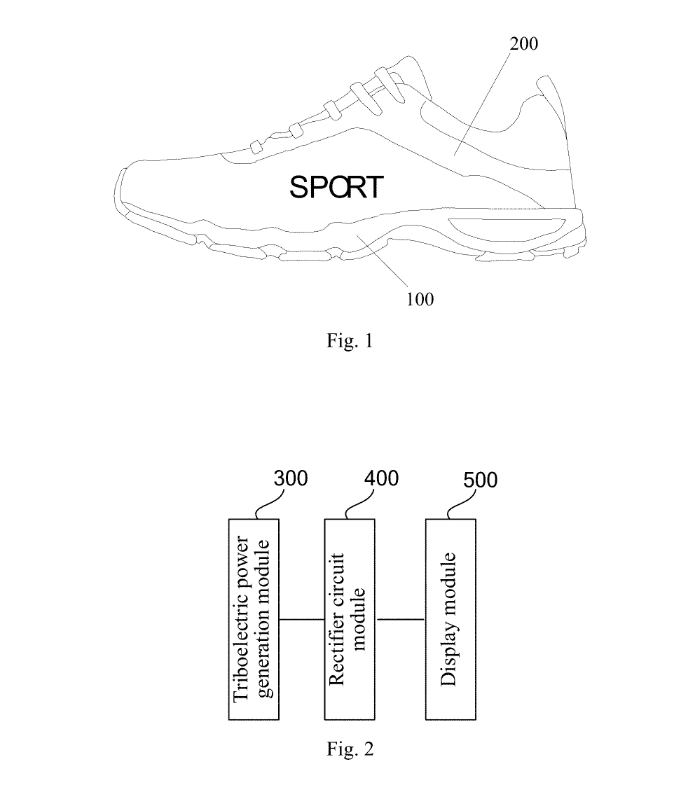

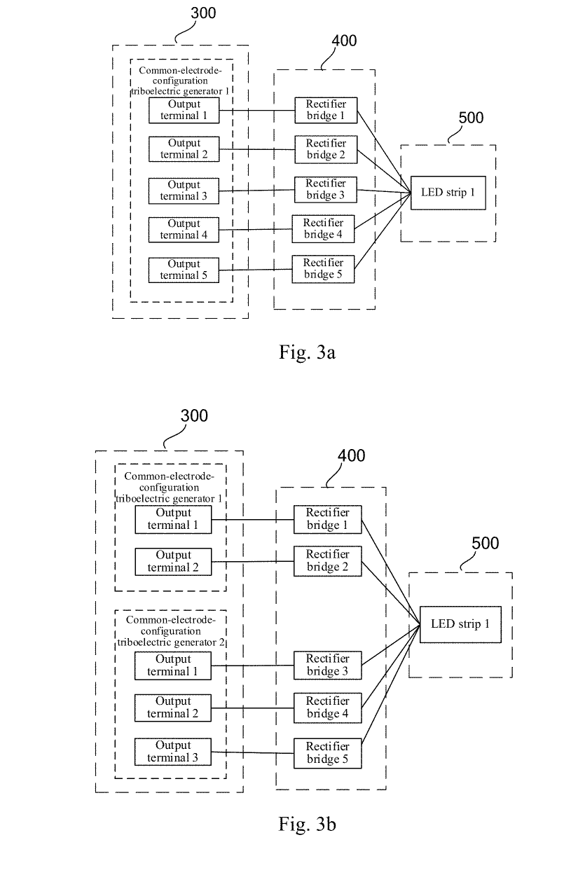

FIG. 1 is a schematic diagram of an overall structure of an embodiment of a light emitting shoe provided by the present invention, as shown in FIG. 1, in the embodiment, the light emitting shoe includes a sole 100 and a vamp 200, and further includes a triboelectric power generation module 300, a rectifier circuit module 400 and a display module 500 as shown in FIG. 2. The triboelectric power generation module 300 and the rectifier circuit module 400 are located at the sole, and the display module 500 is located on the sole and/or the vamp; the triboelectric power generation module 300 includes at least one triboelectric generator for converting mechanical energy into electric energy, that is, the triboelectric power generation module 300 detects an external force acting on the sole during walking, and converts the mechanical energy generated by the detected external force into the electric energy for output; the rectifier circuit module 400 includes at least one rectifier bridge connected with the triboelectric power generation module 300 and used for rectifying the electric energy output by the triboelectric power generation module 300; and the display module 500 is connected with the rectifier circuit module 400 and is used for receiving the electric energy output by the rectifier circuit module 400 to achieve light emitting display of the display module 500.

The triboelectric power generation module 300 can include one triboelectric generator and can also include a plurality of triboelectric generators, and those skilled in the art can make choices according to needs, which is not limited herein. If the triboelectric power generation module 300 includes a plurality of triboelectric generators, the plurality of triboelectric generators can be connected in series and/or in parallel, and the plurality of triboelectric generators connected in series and/or in parallel can be arranged inside the sole in a laminated and/or tiled manner.

The triboelectric generator in the triboelectric power generation module 300 includes a triboelectric generator electrode, for example, the triboelectric generator is a common-electrode-configuration triboelectric generator including the triboelectric generator electrode, and those skilled in the art can make choices according to needs, which is not limited herein. Since the triboelectric power generation module 300 is a core component in the light emitting shoe, the specific structures of the triboelectric generator electrode and the triboelectric generator including the triboelectric generator electrode will be separately described later in detail. The connecting modes of the modules mentioned above will be introduced below at first.

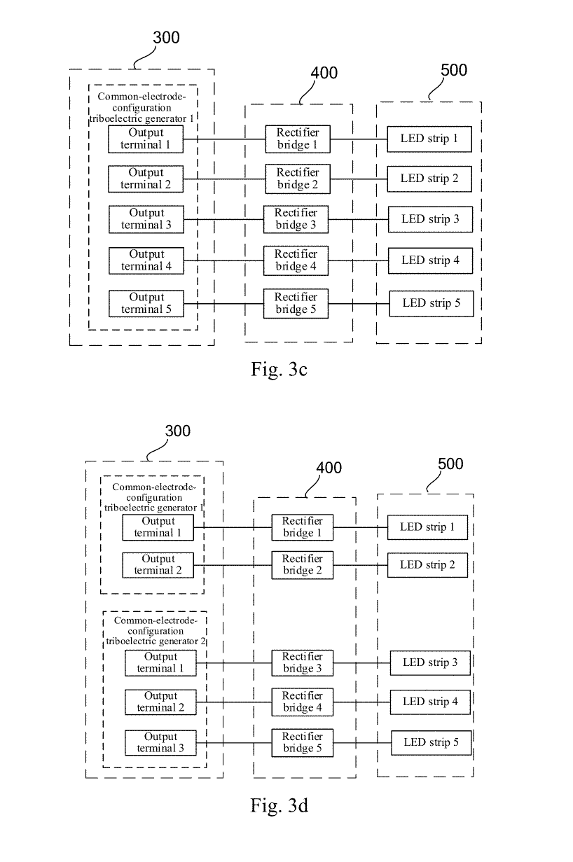

With respect to the specific connecting modes of the triboelectric power generation module 300, the rectifier circuit module 400 and the display module 500, reference may be made to FIGS. 3a to 3k.

### First Embodiment of the Light Emitting Shoe

The triboelectric power generation module 300 can include at least one common-electrode-configuration triboelectric generator, the rectifier circuit module 400 can include at least one rectifier bridge, and the display module can include a single LED strip. Multiple groups of output terminals of the common-electrode-configuration triboelectric generator can be connected with a plurality of rectifier bridges in a one-to-one correspondence manner respectively. The single LED strip can be connected with the plurality of rectifier bridges.

As shown in FIG. 3a, the triboelectric power generation module 300 includes one common-electrode-configuration triboelectric generator, namely common-electrode-configuration triboelectric generator 1; the rectifier circuit module 400 includes 5 rectifier bridges, namely rectifier bridge 1, rectifier bridge 2, rectifier bridge 3, rectifier bridge 4 and rectifier bridge 5; and the display module 500 includes one LED strip, namely LED strip 1. The common-electrode-configuration triboelectric generator 1 has 5 groups of output terminals, namely output terminal 1, output terminal 2, output terminal 3, output terminal 4 and output terminal 5, that is to say, the triboelectric power generation module 300 has 5 groups of output terminals in total, the 5 groups of output terminals are independently connected with the 5 rectifier bridges in the one-to-one correspondence manner, that is, the output terminal 1 of the common-electrode-configuration triboelectric generator 1 is connected with the rectifier bridge 1, the output terminal 2 of the common-electrode-configuration triboelectric generator 1 is connected with the rectifier bridge 2, the output terminal 3 of the common-electrode-configuration triboelectric generator 1 is connected with the rectifier bridge 3, the output terminal 4 of the common-electrode-configuration triboelectric generator 1 is connected with the rectifier bridge 4, the output terminal 5 of the common-electrode-configuration triboelectric generator 1 is connected with the rectifier bridge 5, and the 5 groups of output terminals of the triboelectric power generation module 300 are connected with the 5 rectifier bridges in the one-to-one correspondence manner so as to output electric energy to the rectifier bridges correspondingly connected thereto. The LED strip 1 is connected with the 5 rectifier bridges at the same time, and the 5 rectifier bridges provide all the rectified electric energy to the LED strip 1, so that the LED strip 1 emits light.

As shown in FIG. 3b, the triboelectric power generation module 300 includes 2 common-electrode-configuration triboelectric generators, namely common-electrode-configuration triboelectric generator 1 and common-electrode-configuration triboelectric generator 2; the rectifier circuit module 400 includes 5 rectifier bridges, namely rectifier bridge 1, rectifier bridge 2, rectifier bridge 3, rectifier bridge 4 and rectifier bridge 5; and the display module 500 includes a single LED strip, namely LED strip 1. The common-electrode-configuration triboelectric generator 1 has 2 groups of output terminals, namely output terminal 1 and output terminal 2, the common-electrode-configuration triboelectric generator 2 has 3 groups of output terminals, namely output terminal 1, output terminal 2 and output terminal 3, that is to say, the triboelectric power generation module 300 has 5 groups of output terminals in total, the 5 groups of output terminals are independently connected with the 5 rectifier bridges in the one-to-one correspondence manner, that is, the output terminal 1 of the common-electrode-configuration triboelectric generator 1 is connected with the rectifier bridge 1, the output terminal 2 of the common-electrode-configuration triboelectric generator 1 is connected with the rectifier bridge 2, the output terminal 1 of the common-electrode-configuration triboelectric generator 2 is connected with the rectifier bridge 3, the output terminal 2 of the common-electrode-configuration triboelectric generator 2 is connected with the rectifier bridge 4, the output terminal 3 of the common-electrode-configuration triboelectric generator 2 is connected with the rectifier bridge 5, and the 5 groups of output terminals of the triboelectric power generation module 300 are connected with the 5 rectifier bridges in the one-to-one correspondence manner so as to output electric energy to the rectifier bridges correspondingly connected thereto. The LED strip 1 is connected with the 5 rectifier bridges at the same time, and the 5 rectifier bridges provide all the rectified electric energy to the LED strip 1, so that the LED strip 1 emits light.

### Second Embodiment of the Light Emitting Shoe

The triboelectric power generation module 300 can include at least one common-electrode-configuration triboelectric generator, the rectifier circuit module 400 can include at least one rectifier bridge, and the display module can include a plurality of LED strips. Multiple groups of output terminals of the common-electrode-configuration triboelectric generator can be connected with a plurality of rectifier bridges in a one-to-one correspondence manner respectively. The plurality of LED strips can be connected with the plurality of rectifier bridges in a one-to-one correspondence manner respectively.

As shown in FIG. 3c, the triboelectric power generation module 300 includes one common-electrode-configuration triboelectric generator, namely common-electrode-configuration triboelectric generator 1; and the rectifier circuit module 400 includes 5 rectifier bridges, namely rectifier bridge 1, rectifier bridge 2, rectifier bridge 3, rectifier bridge 4 and rectifier bridge 5. The connecting mode of the triboelectric power generation module 300 and the rectifier circuit module 400 is the same as the connecting mode of the triboelectric power generation module and the rectifier circuit module shown in FIG. 3a in the first embodiment, and thus will not be repeated herein. The difference lies in that the display module 500 includes 5 LED strips, namely LED strip 1, LED strip 2, LED strip 3, LED strip 4 and LED strip 5, the 5 LED strips are connected with the 5 rectifier bridges in a one-to-one correspondence manner, that is, the rectifier bridge 1 is connected with the LED strip 1, the rectifier bridge 2 is connected with the LED strip 2, the rectifier bridge 3 is connected with the LED strip 3, the rectifier bridge 4 is connected with the LED strip 4, the rectifier bridge 5 is connected with the LED strip 5, and the 5 rectifier bridges respectively provide the rectified electric energy to the 5 LED strips correspondingly connected thereto, so that the 5 LED strips emit light.

As shown in FIG. 3d, the triboelectric power generation module 300 includes 2 common-electrode-configuration triboelectric generators, namely common-electrode-configuration triboelectric generator 1 and common-electrode-configuration triboelectric generator 2; and the rectifier circuit module 400 includes 5 rectifier bridges, namely rectifier bridge 1, rectifier bridge 2, rectifier bridge 3, rectifier bridge 4 and rectifier bridge 5. The connecting mode of the triboelectric power generation module 300 and the rectifier circuit module 400 is the same as the connecting mode of the triboelectric power generation module and the rectifier circuit module shown in FIG. 3b in the first embodiment, and thus will not be repeated herein. The difference lies in that the display module 500 includes 5 LED strips, namely LED strip 1, LED strip 2, LED strip 3, LED strip 4 and LED strip 5, the 5 LED strips are connected with the 5 rectifier bridges in a one-to-one correspondence manner, that is, the rectifier bridge 1 is connected with the LED strip 1, the rectifier bridge 2 is connected with the LED strip 2, the rectifier bridge 3 is connected with the LED strip 3, the rectifier bridge 4 is connected with the LED strip 4, the rectifier bridge 5 is connected with the LED strip 5, and the 5 rectifier bridges respectively provide the rectified electric energy to the 5 LED strips correspondingly connected thereto, so that the 5 LED strips emit light.

### Third Embodiment of the Light Emitting Shoe

The triboelectric power generation module 300 can include at least one common-electrode-configuration triboelectric generator, the rectifier circuit module 400 can include at least one rectifier bridge, and the display module 500 can include a plurality of LED strips. Multiple groups of output terminals of the common-electrode-configuration triboelectric generator can be connected with a plurality of rectifier bridges in a one-to-one correspondence manner respectively, and the plurality of LED strips can be connected with the plurality of rectifier bridges in series and/or in parallel.

As shown in FIG. 3e, the triboelectric power generation module 300 includes one common-electrode-configuration triboelectric generator, namely common-electrode-configuration triboelectric generator 1; and the rectifier circuit module 400 includes 5 rectifier bridges, namely rectifier bridge 1, rectifier bridge 2, rectifier bridge 3, rectifier bridge 4 and rectifier bridge 5. The connecting mode of the triboelectric power generation module 300 and the rectifier circuit module 400 is the same as the connecting mode of the triboelectric power generation module and the rectifier circuit module shown in FIG. 3a in the first embodiment, and thus will not be repeated herein. The difference lies in that the display module 500 includes 7 LED strips, namely LED strip 1, LED strip 2, LED strip 3, LED strip 4, LED strip 5, LED strip 6 and LED strip 7, wherein the LED strip 1 is connected with the rectifier bridge 1 in a one-to-one correspondence manner, the LED strip 2, the LED strip 3 and the LED strip 4 are connected with the rectifier bridge 2 in series or in parallel or in series and parallel (the specific serial and/or parallel connecting mode is not shown in the figure), the LED strip 5 is connected with the rectifier bridge 3 and the rectifier bridge 4 at the same time, and the LED strip 6 and the LED strip 7 are connected with the rectifier bridge 5 in series or in parallel (the specific serial and/or parallel connecting mode is not shown in the figure). The 5 rectifier bridges provide the rectified electric energy to the 7 LED strips correspondingly connected thereto, so that the 7 LED strips emit light.

As shown in FIG. 3f, the triboelectric power generation module 300 includes 2 common-electrode-configuration triboelectric generators, namely common-electrode-configuration triboelectric generator 1 and common-electrode-configuration triboelectric generator 2; and the rectifier circuit module 400 includes 5 rectifier bridges, namely rectifier bridge 1, rectifier bridge 2, rectifier bridge 3, rectifier bridge 4 and rectifier bridge 5. The connecting mode of the triboelectric power generation module 300 and the rectifier circuit module 400 is the same as the connecting mode of the triboelectric power generation module and the rectifier circuit module shown in FIG. 3b in the first embodiment, and thus will not be repeated herein. The difference lies in that the display module 500 includes 7 LED strips, namely LED strip 1, LED strip 2, LED strip 3, LED strip 4, LED strip 5, LED strip 6 and LED strip 7, wherein the LED strip 1 is connected with the rectifier bridge 1 in a one-to-one correspondence manner, the LED strip 2, the LED strip 3 and the LED strip 4 are connected with the rectifier bridge 2 in series or in parallel or in series and parallel (the specific serial and/or parallel connecting mode is not shown in the figure), the LED strip 5 is connected with the rectifier bridge 3 and the rectifier bridge 4 at the same time, and the LED strip 6 and the LED strip 7 are connected with the rectifier bridge 5 in series or in parallel (the specific serial and/or parallel connecting mode is not shown in the figure). The 5 rectifier bridges provide the rectified electric energy to the 7 LED strips correspondingly connected thereto, so that the 7 LED strips emit light.

### Fourth Embodiment of the Light Emitting Shoe

The triboelectric power generation module 300 can include at least one common-electrode-configuration triboelectric generator, the rectifier circuit module 400 can include at least one rectifier bridge, and the display module 500 can include a single LED strip. Multiple groups of output terminals of the common-electrode-configuration triboelectric generator can also be connected with a plurality of rectifier bridges, and the output terminals of the common-electrode-configuration triboelectric generator connected with one of the rectifier bridges are connected with one another in series and/or in parallel. The single LED strip is connected with the plurality of rectifier bridges.

As shown in FIG. 3g, the triboelectric power generation module 300 includes 4 common-electrode-configuration triboelectric generators, namely common-electrode-configuration triboelectric generator 1, common-electrode-configuration triboelectric generator 2, common-electrode-configuration triboelectric generator 3 and common-electrode-configuration triboelectric generator 4; and the rectifier circuit module 400 includes 5 rectifier bridges, namely rectifier bridge 1, rectifier bridge 2, rectifier bridge 3, rectifier bridge 4 and rectifier bridge 5; the display module 500 can include 1 LED strip. The common-electrode-configuration triboelectric generator 1 has 2 groups of output terminals, namely output terminal 1 and output terminal 2, the common-electrode-configuration triboelectric generator 2 has 3 groups of output terminals, namely output terminal 1, output terminal 2 and output terminal 3, the common-electrode-configuration triboelectric generator 3 has 2 groups of output terminals, namely output terminal 1 and output terminal 2, the common-electrode-configuration triboelectric generator 4 has 2 groups of output terminals, namely output terminal 1 and output terminal 2, that is to say, the triboelectric power generation module 300 has 7 groups of output terminals in total. The 7 groups of output terminals are connected with the 5 rectifier bridges in series and/or in parallel, the output terminal 1 and the output terminal 2 of the common-electrode-configuration triboelectric generator 1 are connected with the rectifier bridge 1 in series or in parallel (the specific serial and/or parallel connecting mode is not shown in the figure), the output terminal 1, the output terminal 2 and the output terminal 3 of the common-electrode-configuration triboelectric generator 2 are connected with the rectifier bridge 2 in series or in parallel or in series and parallel (the specific serial and/or parallel connecting mode is not shown in the figure), the output terminal 1 of the common-electrode-configuration triboelectric generator 3 is connected with the rectifier bridge 3, the output terminal 2 of the common-electrode-configuration triboelectric generator 3 and the output terminal 1 of the common-electrode-configuration triboelectric generator 4 are connected with the rectifier bridge 4 in series or in parallel (the specific serial and/or parallel connecting mode is not shown in the figure), the output terminal 2 of the common-electrode-configuration triboelectric generator 4 is connected with the rectifier bridge 5, and the 7 groups of output terminals are connected with the 5 rectifier bridges so as to output electric energy to the rectifier bridges correspondingly connected thereto. The LED strip 1 is connected with the 5 rectifier bridges at the same time, and the 5 rectifier bridges provide all the rectified electric energy to the LED strip 1 connected thereto, so that the LED strip 1 emits light.

### Fifth Embodiment of the Light Emitting Shoe

The triboelectric power generation module can include at least one common-electrode-configuration triboelectric generator, the rectifier circuit module can include at least one rectifier bridge, and the display module can include a plurality of LED strips. Multiple groups of output terminals of the common-electrode-configuration triboelectric generator can also be connected with a plurality of rectifier bridges, and the output terminals of the common-electrode-configuration triboelectric generator connected with one of the rectifier bridges are connected with one another in series and/or in parallel. The plurality of LED strips can be respectively connected with the plurality of rectifier bridges in a one-to-one correspondence manner. The connecting mode of the triboelectric power generation module and the rectifier circuit module is the same as the connecting mode of the triboelectric power generation module and the rectifier circuit module shown in FIG. 3g in the fourth embodiment, and the connecting mode of the plurality of LED strips and the rectifier circuit module is the same as the connecting mode of the plurality of LED strips and the rectifier circuit module shown in FIG. 3d in the second embodiment, and thus will not be repeated herein.

### Sixth Embodiment of the Light Emitting Shoe

The triboelectric power generation module can include at least one common-electrode-configuration triboelectric generator, the rectifier circuit module can include at least one rectifier bridge, and the display module can include a plurality of LED strips. Multiple groups of output terminals of the common-electrode-configuration triboelectric generator can also be connected with a plurality of rectifier bridges, and the output terminals of the common-electrode-configuration triboelectric generator connected with one of the rectifier bridges are connected with one another in series and/or in parallel. The plurality of LED strips can also be connected with the plurality of rectifier bridges in series and/or in parallel. The connecting mode of the triboelectric power generation module and the rectifier circuit module is the same as the connecting mode of the triboelectric power generation module and the rectifier circuit module shown in FIG. 3g in the fourth embodiment, and the connecting mode of the plurality of LED strips and the rectifier circuit module is the same as the connecting mode of the plurality of LED strips and the rectifier circuit module shown in FIG. 3f in the third embodiment, and thus will not be repeated herein.

### Seventh Embodiment of the Light Emitting Shoe

The triboelectric power generation module 300 can include at least one common-electrode-configuration triboelectric generator, the rectifier circuit module 400 can include one rectifier bridge, and the display module 500 can include a single LED strip. Multiple groups of output terminals of the common-electrode-configuration triboelectric generator are connected with the one rectifier bridge, and the output terminals of the common-electrode-configuration triboelectric generator connected with the one rectifier bridge are connected with one another in series and/or in parallel. The single LED strip is connected with the one rectifier bridge.

As shown in FIG. 3h, the triboelectric power generation module 300 includes one common-electrode-configuration triboelectric generator, namely common-electrode-configuration triboelectric generator 1; the rectifier circuit module 400 includes one rectifier bridge, namely rectifier bridge 1; and the display module 500 includes one LED strip, namely LED strip 1. The common-electrode-configuration triboelectric generator 1 has 4 groups of output terminals. namely output terminal 1, output terminal 2, output terminal 3 and output terminal 4, that is to say, the triboelectric power generation module 300 has 4 groups of output terminals in total, the 4 groups of output terminals are connected in series and/or in parallel and are then connected with the one rectifier bridge, that is, the output terminal 1, the output terminal 2, the output terminal 3 and the output terminal 4 of the common-electrode-configuration triboelectric generator 1 are connected in series or in parallel or in series and parallel (the specific serial and/or parallel connecting mode is not shown in the figure) and are then connected with the rectifier bridge 1 so as to output electric energy to the rectifier bridge 1 connected thereto. The LED strip 1 is connected with the rectifier bridge 1, and the rectifier bridge 1 provides the rectified electric energy to the LED strip 1 connected thereto, so that the LED strip 1 emits light.

As shown in FIG. 3i, the triboelectric power generation module 300 includes 2 common-electrode-configuration triboelectric generators, namely common-electrode-configuration triboelectric generator 1 and common-electrode-configuration triboelectric generator 2; the rectifier circuit module 400 includes one rectifier bridge, namely rectifier bridge 1; and the display module 500 includes one LED strip, namely LED strip 1. The common-electrode-configuration triboelectric generator 1 has 2 groups of output terminals, namely output terminal 1 and output terminal 2, the common-electrode-configuration triboelectric generator 2 has 2 groups of output terminals, namely output terminal 1 and output terminal 2, that is to say, the triboelectric power generation module 300 has 4 groups of output terminals in total, the 4 groups of output terminals are connected in series and/or in parallel and are then connected with the rectifier bridge 1, that is, the output terminal 1 and the output terminal 2 of the common-electrode-configuration triboelectric generator 1, and the output terminal 1 and the output terminal 2 of the common-electrode-configuration triboelectric generator 2 are connected in series or in parallel or in series and parallel (the specific serial and/or parallel connecting mode is not shown in the figure) and are then connected with the rectifier bridge 1 so as to output electric energy to the rectifier bridge 1 connected thereto. The LED strip 1 is connected with the rectifier bridge 1, and the rectifier bridge 1 provides the rectified electric energy to the LED strip 1 connected thereto, so that the LED strip 1 emits light.

### Eighth Embodiment of the Light Emitting Shoe

The triboelectric power generation module 300 can include at least one common-electrode-configuration triboelectric generator, the rectifier circuit module 400 can include one rectifier bridge, and the display module 500 can include a plurality of LED strips. Multiple groups of output terminals of the common-electrode-configuration triboelectric generator are connected with the one rectifier bridge, and the output terminals of the common-electrode-configuration triboelectric generator connected with the one rectifier bridge are connected with one another in series and/or in parallel. The plurality of LED strips are connected with the one rectifier bridge in series and/or in parallel.

As shown in FIG. 3j, the triboelectric power generation module 300 includes one common-electrode-configuration triboelectric generator, namely common-electrode-configuration triboelectric generator 1; and the rectifier circuit module 400 includes one rectifier bridge, namely rectifier bridge 1. The connecting mode of the triboelectric power generation module 300 and the rectifier circuit module 400 is the same as the connecting mode of the triboelectric power generation module and the rectifier circuit module shown in FIG. 3h in the seventh embodiment, and thus will not be repeated herein. The difference lies in that the display module 500 includes 4 LED strips, namely LED strip 1, LED strip 2, LED strip 3 and LED strip 4. The LED strip 1, the LED strip 2, the LED strip 3 and the LED strip 4 are connected in series or in parallel or in series and parallel (the specific serial and/or parallel connecting mode is not shown in the figure) and are then connected with the rectifier bridge 1, and the rectifier bridge 1 provides the rectified electric energy to the 4 LED strips connected thereto, so that the 4 LED strips emit light.

As shown in FIG. 3k, the triboelectric power generation module 300 includes 2 common-electrode-configuration triboelectric generators, namely common-electrode-configuration triboelectric generator 1 and common-electrode-configuration triboelectric generator 2; and the rectifier circuit module 400 includes one rectifier bridge, namely rectifier bridge 1. The connecting mode of the triboelectric power generation module 300 and the rectifier circuit module 400 is the same as the connecting mode of the triboelectric power generation module and the rectifier circuit module shown in FIG. 3i in the seventh embodiment, and thus will not be repeated herein. The difference lies in that the display module 500 includes 4 LED strips, namely LED strip 1, LED strip 2, LED strip 3 and LED strip 4. The LED strip 1, the LED strip 2, the LED strip 3 and the LED strip 4 are connected in series or in parallel or in series and parallel (the specific serial and/or parallel connecting mode is not shown in the figure) and are then connected with the rectifier bridge 1, and the rectifier bridge 1 provides the rectified electric energy to the 4 LED strips connected thereto, so that the 4 LED strips emit light.

The foregoing descriptions are illustrations, the connecting mode can be set according to the actual situation during implementation, and is not specifically limited herein.

The triboelectric power generation module, the rectifier circuit module and the display module can be connected with one another in different connecting modes according to different set distances. When the distances are slightly greater, conducting wires can be used for the connection, and when the distances are smaller, terminals can be directly used for the connection.

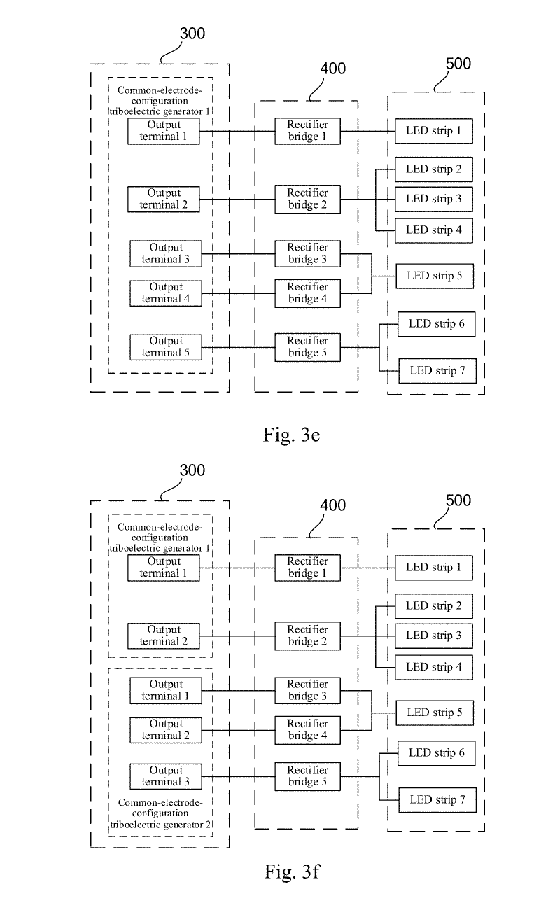

The positions of the modules can be flexibly designed as required, for example, as shown in FIG. 4, the triboelectric power generation module 300 and the rectifier circuit module 400 are arranged at the sole, for example, the triboelectric power generation module 300 and the rectifier circuit module 400 can be arranged inside a contact position between the sole and a forefoot and/or an arch and/or a heel; the display module 500 can also be arranged at the sole, wherein the sole includes a bottom surface and a side face of the sole, the display module 500 is arranged on the side face of the sole so as not to affect the light emitting effect thereof. In addition, the display module 500 can also be arranged on a side of the upper and/or on a front end and/or a back end of the light emitting shoe, etc.; and the display module 500 can also be arranged on the vamp. For the convenience of setting, the vamp can also be made into a double-layer vamp, which includes a transparent surface layer and an inner layer with the display module 500 arranged therebetween, so that neither the comfort of the shoe body itself nor the aesthetic appearance of the shoe body is affected, and the phenomenon that the display module 500 is worn is also effectively prevented. Of course, the display module 500 can also be directly attached to the outer surface of the light emitting shoe.

The LED strips are used as the display module, wherein the LED strips can be arranged in various preset shapes, for example, can be arranged in various shapes such as Chinese character shapes, Pinyin shapes, and patterns of animals and plants, in order to meet the aesthetic needs and interesting needs of people. In addition, a plurality of LED strips can also be arranged into the shape of the logo of the light emitting shoe (for example, a product logo) so as to highlight the logo in the dark, thereby being conducive to improving the brand awareness. The plurality of LED strips can be connected in series and can also be connected in parallel, the serial connection circuit is relatively simple and can guarantee the constant current passing through the LEDs, so that the brightness of the LEDs is more uniform; and the reliability of the parallel connection circuit is higher, and a proper connecting manner can be selected as required in specific design. In general, when the light emitting shoe needs to provide greater brightness, the plurality of LED strips can be connected in series, so that the current flowing through the plurality of LED strips is greater due to the properties of dividing voltage while not dividing current of the serial connection circuit, thereby providing greater brightness. In addition, in order to make the shape formed by the LED strips be more vivid, a light-transparent cover covering the outside of the LED strips can be further arranged on the light emitting shoe, and the shape of the light is changed by the light-transparent cover. For example, a light-transparent part that can let light pass through can be further arranged on the light-transparent cover, and the light-transparent part can be achieved by hollow pores, and can also be achieved by a light-transparent material. The shape of the light-transparent part not only can be a Chinese character shape, a Pinyin shape or the product logo shape of the light emitting shoe, but also can be other more elaborate shape, such as the shape of a flower, a bird, a fish, an insect or the like. In this way, the emitted light can be in the same shape as the light-transparent part, and thus the visual effect of the light emitting shoe is further improved. The shape of the light emitted by the LED strips can be optimized, via the light-transparent cover, into various precise shapes which are difficult to realize only by the arrangement of the LED strips.

Finally, the specific structures of the core components, namely the triboelectric generator electrode and the common-electrode-configuration triboelectric generator, in the light emitting shoe provided by the embodiments of the present invention will be described in detail.

The triboelectric generator electrode in the present invention includes a porous electrode layer and a high molecular polymer insulating layer, and the porous electrode layer and the high molecular polymer insulating layer are mutually embedded to form an embedded body.

The porous electrode layer is a porous metal having a foam-like structure or a sponge-like structure or a composite porous body thereof, for example, it can be at least one of commercially available nickel foam, copper foam, aluminum foam, porous iron, porous copper or a composite porous body thereof.

The high molecular polymer insulating layer can be a commercially available thermoplastic or thermosetting high molecular material, for example, can be commercially available PDMS (polydimethylsiloxane), methyl vinyl silicone rubber, fluorinated silicone rubber, phenolic resin or vulcanized rubber.

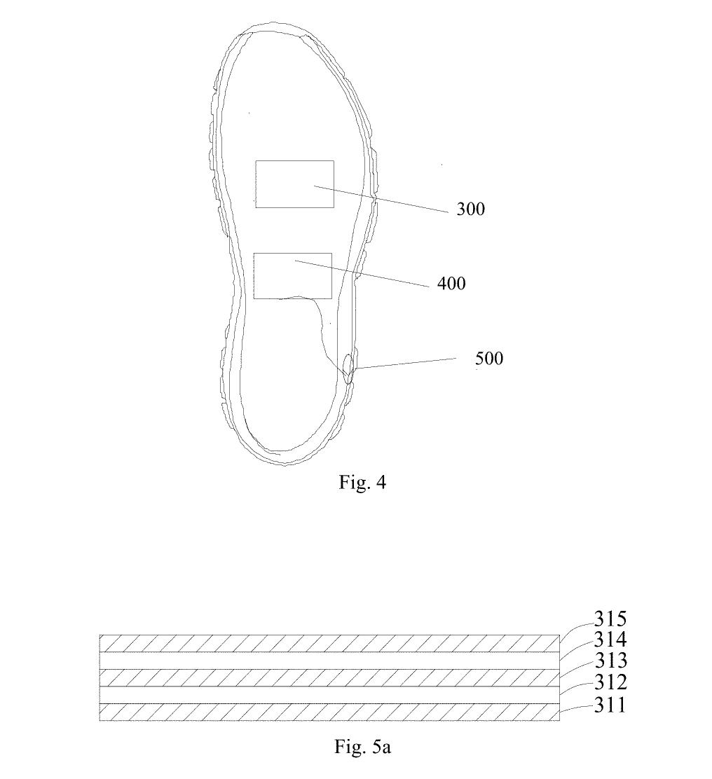

FIG. 8 is a structural schematic diagram of a specific embodiment of a triboelectric generator electrode in the present invention. As shown in FIG. 8, the triboelectric generator electrode in the present invention includes a porous electrode layer 1 and a high molecular polymer insulating layer 2, a part of the porous electrode layer 1 and a part of the high molecular polymer insulating layer 2 are mutually embedded to form a partially embedded body, and the other part of the porous electrode layer 1 and the other part of the high molecular polymer insulating layer 2 are exposed at the outside.

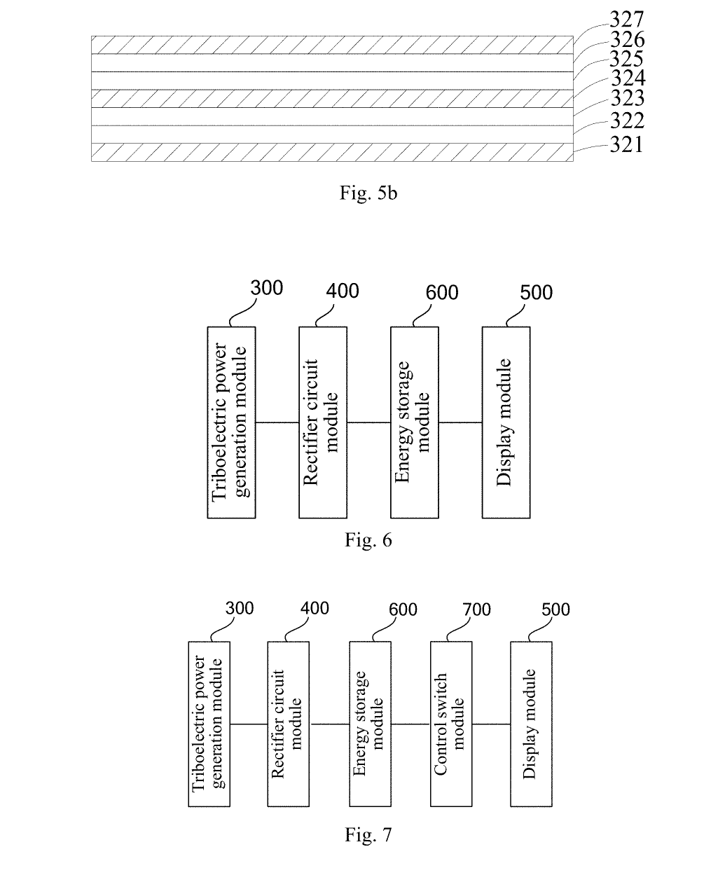

FIG. 9 is a structural schematic diagram of another specific embodiment of a triboelectric generator electrode in the present invention. As shown in FIG. 9, the triboelectric generator electrode in the present invention includes a porous electrode layer and a high molecular polymer insulating layer, and the porous electrode layer and the high molecular polymer insulating layer are embedded to form a completely embedded body.

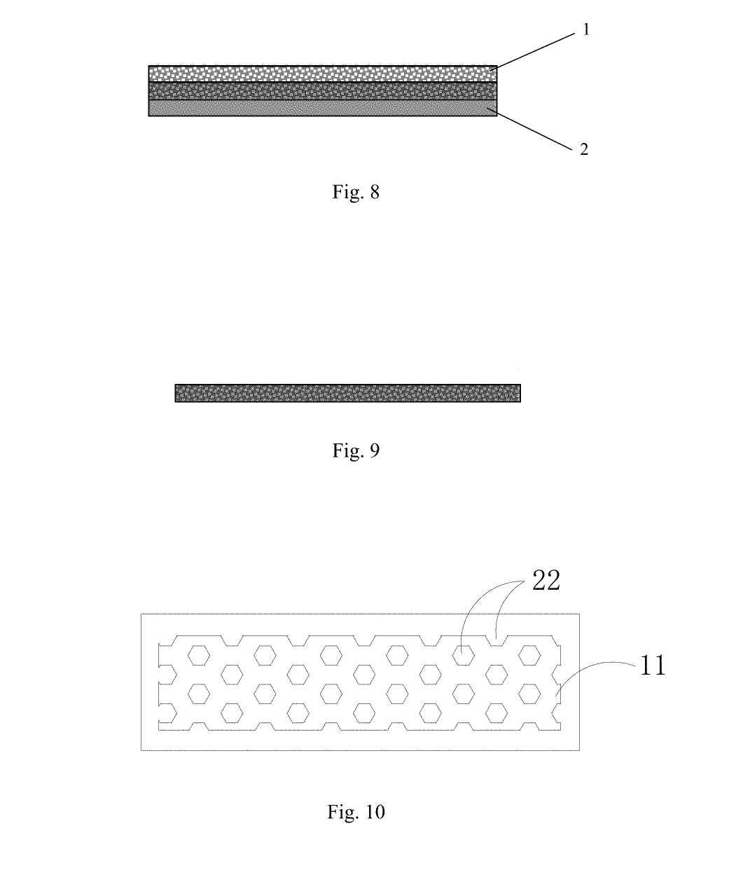

FIG. 10 is a section view of an embedded body of a triboelectric generator electrode in the present invention. As shown in FIG. 10, in the embedded body, the porous electrode layer and the high molecular polymer insulating layer are mutually embedded, a polymer 22 in the high molecular polymer insulating layer covers a porous electrode 11, and the polymer 22 enters micropores of the porous electrode 11.

As shown in FIGS. 8, 9 and 10, in the arrangement manner of the triboelectric generator electrode in the present invention, the porous metal or its composite porous body as a whole is used as an electrode layer of the triboelectric generator and forms good fitting with the high molecular polymer insulating layer, so that on one hand, the fastness of the electrode is increased and the electrode is unlikely to fall off, and on the other hand, compared with a planar electrode layer, the specific surface area is greater due to the porous structure of the electrode, so a greater contact area is formed with the high molecular polymer insulating layer, and thus more charges can be sensed; and in a specific embodiment in which the porous electrode layer is nickel foam, the power generation performance of the triboelectric generator is increased by about 30%.

In addition, due to the porous structure of the porous metal itself, the arrangement manner of the triboelectric generator electrode in the present invention achieves better flexibility than the flat plate structure, and the overall flexibility of the triboelectric generator is improved.

The electrode having the structure in the present invention can be applied to three-layer (friction between the polymer and the triboelectric electrode), four-layer (friction between the polymer and the polymer), five-layer (an intermediate film triboelectric generator and an intermediate electrode triboelectric generator), spring, arch, metal oxide and polymer and other structures of nano-triboelectric generators, and can also be applied to three-layer and four-layer structures of common-electrode-configuration triboelectric generators.

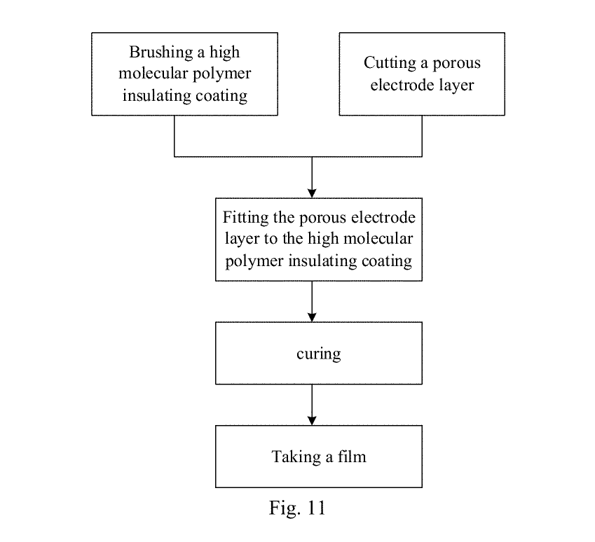

In another aspect, as shown in FIG. 11, the manufacturing method of the triboelectric generator electrode in the present invention includes the following steps:
(1) brushing a first high molecular polymer insulating coating on the surface of a template having a microstructure, and carrying out a degassing treatment;
wherein the template is a template having a microstructure, which is conventionally used in the art, for example, the template can be a silicon template, glass, metal, organic glass or the like; the microstructure is a micro-nano concave-convex structure with a protrusion height of 50-3000 nm; and the degassing treatment is achieved by vacuumizing.

The polymer used in the present invention can be a commercially available thermoplastic or thermosetting high molecular material, for example, can be commercially available PDMS (polydimethylsiloxane), methyl vinyl silicone rubber, fluorinated silicone rubber, phenolic resin or vulcanized rubber.

The high molecular polymer insulating coating is slurry obtained by uniformly mixing a high molecular material with a curing agent, or slurry formed by uniformly mixing the high molecular material with the curing agent and then dissolving the mixture in an organic solvent, and a proper curing agent type and organic solvent type is selected according to the selected type of the high molecular material.

The high molecular material can be PDMS; the slurry is manufactured by uniformly mixing the PDMS with the curing agent, dissolving the mixture in the organic solvent, and performing uniform stirring; the organic solvent is normal hexane, cyclohexane, toluene, xylene, ethyl acetate or butyl acetate; preferably, the mass ratio of the solid (mixture) to the organic solvent in the PDMS slurry is 1:20; the curing agent is a vulcanizing agent, for example, commercially available Dow Corning 184, and in this case, the weight ratio of the high molecular material to the curing agent is 5:1 to 20:1, and is preferably 10:1; the curing temperature is 60-120° C., and preferably, heating can be performed in the stirring process.

The high molecular material PDMS is liquid itself, it is also possible that the organic solvent is not used and only the curing agent is added to the high molecular material, wherein the weight ratio of the high molecular material to the curing agent is 5:1 to 20:1, and is preferably 10:1.

Similarly, the high molecular material can also be liquid phenolic resin including benzene phenolic resin and formaldehyde resin; the curing agent can be cycloaliphatic polyamines, tertiary amines, imidazoles and boron trifluoride complexes and the like; and the curing temperature is 60-120° C.

The high molecular material can also be liquid methyl vinyl silicone rubber or fluorinated silicone rubber; the curing agent can be ethyl orthosilicate or organic tin; and the curing temperature is 60-120° C.

The high molecular material can also be vulcanized rubber, and the polymer slurry used in a brushing process is a mixture of rubber that can be crosslinked by sulfur or peroxide, and sulfur or peroxide. Then, the triboelectric generator electrode in the present invention is obtained by embedding porous metal with the vulcanized rubber in a rubber vulcanization process.

The brushing is achieved by using a coating machine.

The coating machine includes a frame, a scraper arranged on the frame, a coating roller, a back roller and a slurry container; wherein the coating roller and the back roller are arranged in the same row in parallel and move in the same direction, the slurry container is connected with the coating roller, and the scraper is arranged above the coating roller with a gap from the surface of the coating roller; and a base material runs around the back roller. The coating machine is commercially available, for example, the TB-800 type silicone oil coating machine.

In a coating process, the amount of the slurry conveyed from the slurry container to the coating roller is adjusted by adjusting the gap between the scraper and the coating roller.

In the coating process, the rotating speed of the coating roller is 10-120 m/min, and the rotating speed of the back roller is 10-120 m/min.
(2) Cutting a porous electrode layer with a smooth surface into a target size, and adhering an electrode lead.

Preferably, flattening treatment is performed on the porous electrode layer, so that its thickness reaches a target thickness and its surface is smooth; and the flattening treatment is performed by using a twin-roller machine.

The target size of the porous electrode layer is equal to or slightly smaller than the size of the formed first high molecular polymer insulating coating. When the first high molecular polymer insulating coating covers the porous electrode layer, the size of the porous electrode layer is smaller than that of the first high molecular polymer insulating coating, wherein the size of the first high molecular polymer insulating coating is the same as that of the triboelectric generator. For example, when it is required that the size of the triboelectric generator is 6.3 cm×4.3 cm, the size of the first high molecular polymer insulating coating can be 6.3 cm×4.3 cm, and the size of the porous electrode layer can be 6.3 cm×4.3 cm and can also be slightly smaller than 6.3 cm×4.3 cm.

The target thickness of the porous electrode is 250-300 μm.
(3) Fitting the porous electrode layer to the surface of the first high molecular polymer insulating coating, and carrying out a curing treatment.

The curing is to perform a heating treatment on the template coated with the first high molecular polymer insulating coating and is generally performed in an oven; and a proper curing temperature should be selected according to the selected high molecular material type and curing agent type and is generally 60-120° C.
(4) Taking a first high molecular polymer insulating coating/porous electrode layer composite film from the surface of the template.

The film taking procedure is performed according to the conventional method in the art.

Further, the template coated with the first high molecular polymer insulating coating and subjected to the degassing treatment in step (1) is placed in the oven to perform the curing treatment, and before the porous electrode layer is fitted, a second high molecular polymer insulating coating is brushed on the surface of the cured first high molecular polymer insulating coating, then the porous electrode layer treated in step (2) is fitted to the surface of the second high molecular polymer insulating coating, the porous electrode layer is adhered on the surface of the second high molecular polymer insulating coating by the sticky property of the second high molecular polymer insulating coating, and then the template is placed in the oven for curing.

Further, before step (4) is executed, a third high molecular polymer insulating coating is brushed on the cured porous electrode layer, and vacuumizing degassing treatment is performed, so that the third high molecular polymer insulating coating on the surface permeates into the porous electrode layer, and then the template is placed in the oven for curing, so that they are embedded into an entirety.

Or, further, the template coated with the first high molecular polymer insulating coating and subjected to the degassing treatment in step (1) is placed in the oven with a temperature of 60-120° C. to perform semi-curing treatment for 1-10 min, then the porous electrode layer treated in step (2) is fitted to the surface of the semi-cured first high molecular polymer insulating coating, and is preferably placed in the oven for curing.

Further, before step (4) is executed, the second high molecular polymer insulating coating is brushed on the cured porous electrode layer, and the vacuumizing degassing treatment is performed, so that the second high molecular polymer insulating coating on the surface permeates into the porous electrode layer, and then the template is placed in the oven for curing, so that they are embedded into an entirety.

Or, further, no curing treatment is performed on the template coated with the first high molecular polymer insulating coating and subjected to the degassing treatment in step (1), the porous electrode layer treated in step (2) is directly fitted to the surface of the first high molecular polymer insulating coating, and standing in the air is performed for 1-10 min, so that the first high molecular polymer insulating coating on the bottom layer permeates into the porous electrode layer under the action of capillarity, and then the template is placed in the oven for curing, so that they are embedded into an entirety.

In a specific embodiment, the manufacturing method of the triboelectric generator electrode in the present invention includes the following steps:
(1) dissolving a curing agent in a polymer, and performing uniform stirring to prepare polymer slurry;
wherein the polymer is PDMS; the curing agent is a vulcanizing agent, for example, commercially available Dow Corning 184, and in this case, the weight ratio of the polymer to the curing agent is 5:1 to 20:1, and is preferably 10:1; and the curing temperature is 60-120° C.,
(2) brushing a first high molecular polymer insulating coating on the surface of a template having a microstructure, performing a vaccumizing degassing treatment, and curing the template in an oven with a temperature of 60-120° C.,
(3) flattening a porous electrode by using a twin-roller machine, so that its thickness reaches a target thickness and its surface is smooth, and adhering an electrode lead;
(4) brushing a second high molecular polymer insulating coating on the surface of the cured first high molecular polymer insulating coating, fitting the porous electrode layer treated in step (3) to the surface of the second high molecular polymer insulating coating, adhering the porous electrode layer to the surface of the second high molecular polymer insulating coating by the sticky property of the polymer, and then placing the template in the oven with the temperature of 60-120° C. for curing;
(5) brushing a third high molecular polymer insulating coating on the surface of the porous electrode layer, performing a vaccumizing degassing treatment to make the polymer on the surface layer permeate into the micropores of the porous electrode, and curing the template in the oven with the temperature of 60-120° C., so that they are embedded into an entirety; and
(6) taking a polymer/porous electrode layer composite film from the surface of the template.

In another specific embodiment, the manufacturing method of the triboelectric generator electrode in the present invention includes the following steps:
(1) dissolving a curing agent in a polymer, and performing uniform stirring to prepare polymer slurry;
wherein the polymer is PDMS; the curing agent is a vulcanizing agent, for example, commercially available Dow Corning 184, and in this case, the weight ratio of the polymer to the curing agent is 5:1 to 20:1, and is preferably 10:1; and the curing temperature is 60-120° C.,
(2) brushing a first high molecular polymer insulating coating on the surface of a template having a microstructure, performing a vaccumizing degassing treatment, and curing the template in an oven with a temperature of 60-120° C. for 1-10 min, so that the first high molecular polymer insulating coating reaches a semi-cured state;
(3) flattening a porous electrode by using a twin-roller machine, so that its thickness reaches a target thickness and its surface is smooth, and adhering an electrode lead;
(4) fitting the porous electrode treated in step (3) to the surface of the semi-cured first high molecular polymer insulating coating to fix the porous electrode, and then placing the template in the oven for curing;
(5) brushing a second high molecular polymer insulating coating on the surface of the porous electrode layer, performing a vaccumizing degassing treatment to make the polymer on the surface layer permeate into the micropores of the porous electrode, and curing the template in the oven with the temperature of 60-120° C., so that they are embedded into an entirety; and
(6) taking a polymer/porous electrode layer composite film from the surface of the template.

In yet another specific embodiment, the manufacturing method of the triboelectric generator electrode in the present invention includes the following steps:
(1) dissolving a curing agent in a polymer, and performing uniform stirring to prepare polymer slurry;
wherein the polymer is PDMS; the curing agent is a vulcanizing agent, for example, commercially available Dow Corning 184, and in this case, the weight ratio of the polymer to the curing agent is 5:1 to 20:1, and is preferably 10:1; and the curing temperature is 60-120° C.,
(2) brushing a first high molecular polymer insulating coating on the surface of a template having a micro-nano concave-convex structure, and performing a vaccumizing degassing treatment;
(3) flattening a porous electrode by using a twin-roller machine, so that its thickness reaches a target thickness and its surface is smooth, and adhering an electrode lead;
(4) fitting the porous electrode treated in step (3) to the surface of the first high molecular polymer insulating coating, standing in the air for 1-10 min so that the polymer coating on the bottom layer permeates into the micropores of the porous electrode under the action of capillarity, and then placing the template in an oven with a temperature of 60-120° C. for curing, so that they are embedded into an entirety; and
(5) taking a polymer/porous electrode layer composite film from the surface of the template.

The implementation of the method of the present invention is illustrated by specific embodiments below. Those skilled in the art should understand that this should not be construed as limiting the scope of the claims of the present invention.

In the following embodiments, a PET (polyethylene glycol terephthalate)/nickel electrode is used as an example together with the electrode of the present invention to form a triboelectric generator so as to generate electricity, but this does not limit the triboelectric generator, and other high molecular materials/metal electrodes known to those skilled in the art, such as rubber/metal electrodes and the like can also be used with the electrode of the present invention to form the triboelectric generator.

### First Embodiment of the Manufacturing Method of the Triboelectric Generator Electrode

In the present embodiment, the size of the triboelectric generator is 6.3 cm×4.3 cm, and the total thickness is 2.0 mm. The triboelectric generator includes a PDMS/nickel foam electrode having the structure as shown in FIG. 8 in the present invention and a PET/nickel electrode, which are laminated together, wherein the high molecular polymer insulating layer of the triboelectric generator electrode in the present invention and a PET layer of the PET/nickel electrode are arranged oppositely, and the porous electrode layer of the triboelectric generator electrode in the present invention and a nickel metal layer of the PET/nickel electrode are used as voltage and current output terminals of the triboelectric generator. The manufacturing method of the triboelectric generator electrode will be illustrated below in detail.
(1) uniformly mixing a high molecular material PDMS with a curing agent Dow Corning 184 according to a weight ratio of 10:1, heating to 80° C. C., and performing uniform stirring to obtain PDMS slurry;
(2) brushing a first PDMS coating on the surface of a silicon template having a micro-nano concave-convex structure with a height of 150 nm, by using a coating machine, wherein the rotating speed of a coating roller is 50 m/min, the rotating speed of a back roller is 50 m/min, and the gap between a scraper and the coating roller is 150 μm; and performing vacuumizing degassing on the silicon template coated with the first PDMS coating, and curing the silicon template in an oven with a temperature of 100° C. for 10 min;
(3) flattening nickel foam by using a twin-roller machine, so that its thickness reaches 300 μm and its surface is smooth, and adhering an electrode lead;
(4) brushing a second PDMS coating on the surface of the cured first PDMS coating by using the same method, fitting the nickel foam treated in step (3) to the surface of the second PDMS coating, adhering the nickel foam to the surface of the PDMS coating by the sticky property of the PDMS, and then curing the silicon template in the oven with the temperature of 100° C. for 10 min;
(5) brushing a third PDMS coating on the surface of the nickel foam by using the same method, performing a vaccumizing degassing treatment to make the PDMS on the surface layer permeate into the micropores of the nickel foam, and curing the silicon template in the oven with the temperature of 100° C. for 10 min, so that they are embedded into an entirety;
(6) taking a PDMS/nickel foam composite film from the silicon template; and
(7) oppositely laminating the PDMS/nickel foam composite film and the PET layer of the PET/nickel electrode, and packaging the triboelectric generator by using a plastic film to obtain a triboelectric generator sample 1#.

The triboelectric generator sample 1# has good fastness and flexibility. A cyclic pressure test is performed on the triboelectric generator 1# by using a key tester (the MK-9634 key service life tester manufactured by the Dongguan Maike Equipment Co., Ltd.), the test pressure is 15N, the frequency is 2 Hz, and the maximum output voltage and current signals of the triboelectric generator 1# are 450V and 13 μA respectively.

### Second Embodiment of the Manufacturing Method of the Triboelectric Generator Electrode

In the present embodiment, the size of the triboelectric generator is 6.3 cm×4.3 cm, and the total thickness is 2.0 mm. The triboelectric generator includes a PDMS/nickel foam electrode having the structure as shown in FIG. 8 in the present invention and a PET/nickel electrode, which are laminated together, wherein the high molecular polymer insulating layer of the triboelectric generator electrode in the present invention and a PET layer of the PET/nickel electrode are arranged oppositely, and the porous electrode layer of the triboelectric generator electrode in the present invention and a nickel metal layer of the PET/nickel electrode are used as voltage and current output terminals of the triboelectric generator. The manufacturing method of the triboelectric generator electrode will be illustrated below in detail.
(1) uniformly mixing a high molecular material PDMS with a curing agent Dow Corning 184 according to a weight ratio of 10:1, heating to 80° C., and performing uniform stirring to obtain PDMS slurry;
(2) brushing a first PDMS coating on the surface of a glass template having a micro-nano concave-convex structure with a height of 150 nm, by using a coating machine, wherein the rotating speed of a coating roller is 50 m/min, the rotating speed of a back roller is 50 m/min, and the gap between a scraper and the coating roller is 150 μm; and performing vacuumizing degassing on the glass template coated with the first PDMS coating, and curing the glass template in an oven with a temperature of 100° C. for 5 min, so that the first PDMS coating reaches a semi-cured state;
(3) flattening nickel foam by using a twin-roller machine, so that its thickness reaches 250 μm and its surface is smooth, and adhering an electrode lead;
(4) fitting the nickel foam treated in step (3) to the surface of the semi-cured first PDMS coating to fix the same, and curing the glass template in the oven with the temperature of 100° C. for 10 min;
(5) brushing a second PDMS coating on the surface of the nickel foam by using the same method, performing a vaccumizing degassing treatment to make the PDMS on the surface layer permeate into the micropores of the nickel foam, and curing the glass template in the oven with the temperature of 100° C. for 10 min, so that they are embedded into an entirety;
(6) taking a PDMS/nickel foam composite film from the glass template; and
(7) oppositely laminating the PDMS/nickel foam composite film and the PET layer of the PET/nickel electrode, and packaging the triboelectric generator by using a plastic film to obtain a triboelectric generator sample 2#.

The triboelectric generator sample 2# has good fastness and flexibility. A cyclic pressure test is performed on the triboelectric generator 2# by using a key tester (the MK-9634 key service life tester manufactured by the Dongguan Maike Equipment Co., Ltd.), the test pressure is 15N, the frequency is 2 Hz, and the maximum output voltage and current signals of the triboelectric generator 2# are 450V and 13 μA respectively.

### Third Embodiment of the Manufacturing Method of the Triboelectric Generator Electrode

In the present embodiment, the size of the triboelectric generator is 6.3 cm×4.3 cm, and the total thickness is 2.0 mm. The triboelectric generator includes a PDMS/nickel foam electrode having the structure as shown in FIG. 9 in the present invention and a PET/nickel electrode, which are laminated together, wherein the high molecular polymer insulating layer of the triboelectric generator electrode in the present invention and a PET layer of the PET/nickel electrode are arranged oppositely, and the porous electrode layer of the triboelectric generator electrode in the present invention and a nickel metal layer of the PET/nickel electrode are used as voltage and current output terminals of the triboelectric generator. The manufacturing method of the triboelectric generator electrode will be illustrated below in detail.
(1) uniformly mixing a high molecular material PDMS with a curing agent Dow Corning 184 according to a weight ratio of 10:1, heating to 80° C., and performing uniform stirring to obtain PDMS slurry;
(2) brushing a first PDMS coating on the surface of a silicon template having a micro-nano concave-convex structure with a height of 150 nm, by using a coating machine, wherein the rotating speed of a coating roller is 50 m/min, the rotating speed of a back roller is 50 m/min, and the gap between a scraper and the coating roller is 150 μm; and performing vacuumizing degassing on the silicon template coated with the first PDMS coating;
(3) flattening nickel foam by using a twin-roller machine, so that its thickness reaches 300 μm and its surface is smooth, and adhering an electrode lead;
(4) fitting the nickel foam treated in step (3) to the surface of the PDMS coating, standing in the air for 8 min so that the PDMS on the bottom layer permeates into the micropores of the nickel foam under the action of capillarity, and curing the silicon template in an oven with a temperature of 100° C. for 10 min, so that they are embedded into an entirety;
(5) taking a PDMS/nickel foam composite film from the silicon template; and
(6) oppositely laminating the PDMS/nickel foam composite film and the PET layer of the PET/nickel electrode, and packaging the triboelectric generator by using a plastic film to obtain a triboelectric generator sample 3#.

The triboelectric generator sample 3# has good fastness and flexibility. A cyclic pressure test is performed on the triboelectric generator 3# by using a key tester (the MK-9634 key service life tester manufactured by the Dongguan Maike Equipment Co., Ltd.), the test pressure is 15N, the frequency is 2 Hz, and the maximum output voltage and current signals of the triboelectric generator 3# are 450V and 13 μA respectively.

The triboelectric generator electrode in the present invention has good fastness, and thus the triboelectric generator using the electrode in the present invention has improved flexibility and power generation performance. In addition, by adopting the manufacturing method of the triboelectric generator electrode in the present invention, the triboelectric generator electrode can be manufactured conveniently, and the manufacturing process is simple, and the cost is low.

Possible structures of the common-electrode-configuration triboelectric generator will be described below by two embodiments respectively. The common-electrode-configuration triboelectric generator includes the above-mentioned triboelectric generator electrode, and a protrusion structure is arranged on at least one of the two surfaces constituting a triboelectric interface in the common-electrode-configuration triboelectric generator. The protrusion structure is preferably a protrusion structure in a micron order and/or a nanometer order and can be arranged in a rhombus arrangement manner. The protrusion structure can effectively increase the friction contact area, increase the friction resistance and improve the output efficiency of piezoelectric signals.

### First Embodiment of the Common-electrode-configuration Triboelectric Generator

The common-electrode-configuration triboelectric generator includes m electrode layers and n high molecular polymer insulating layers, wherein m is greater than or equal to 3, n is greater than or equal to 2, and m−n is equal to 1. The electrode layers and the high molecular polymer insulating layers are alternately laminated, one or more of the m electrode layers are porous electrode layers, and the porous electrode layers and the high molecular polymer insulating layers laminated thereon are mutually embedded to form an embedded body, and the embedded body is the triboelectric generator electrode described above; the high molecular polymer insulating layers of the triboelectric generator electrode generate mutual friction with other electrode layers of the m electrode layers to form a friction interface; and every two adjacent electrode layers in the common-electrode-configuration triboelectric generator constitute a group of output terminals of the common-electrode-configuration triboelectric generator.

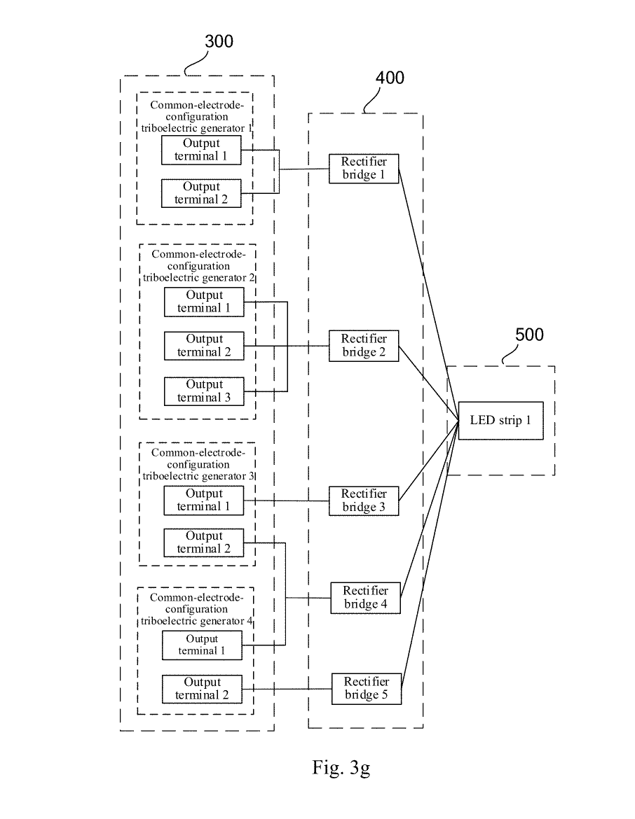

The common-electrode-configuration triboelectric generator as shown in FIG. 5a is of a five-layer structure, which includes 3 electrode layers: a first electrode layer 311, a second electrode layer 313 and a third electrode layer 315, and two high molecular polymer insulating layers: a first high molecular polymer insulating layer 312 and a second high molecular polymer insulating layer 314. The electrode layers and the high molecular polymer insulating layers are alternately laminated, that is, the first electrode layer 311, the first high molecular polymer insulating layer 312, the second electrode layer 313, the second high molecular polymer insulating layer 314 and the third electrode layer 315 are sequentially laminated. Specifically, the second electrode layer 313 can be a porous electrode layer, and the second electrode layer 313 is mutually embedded with the second high molecular polymer insulating layer 314 and the first high molecular polymer insulating layer 312, which are laminated on the upper and lower surfaces thereof, to form the embedded body, that is, the triboelectric generator electrode. The second high molecular polymer insulating layer 314 and the first high molecular polymer insulating layer 312 of the triboelectric generator electrode generate mutual friction with the third electrode layer 315 and the first electrode layer 311 respectively to constitute the friction interface. Every two adjacent electrode layers constitute a group of output terminals of the common-electrode-configuration triboelectric generator, that is, the first electrode layer 311 and the second electrode layer 313, and the second electrode layer 313 and the third electrode layer 315 form two groups of output terminals. Optionally, a protrusion structure is arranged on at least one of the two surfaces constituting the friction interface, that is, the protrusion structure is arranged on at least one of the two surfaces that generate mutual contact friction, namely, the first electrode layer 311 and the first high molecular polymer insulating layer 312 and/or the second high molecular polymer insulating layer 314 and the third electrode layer 315.

### Second Embodiment of the Common-Electrode-Configuration Triboelectric Generator

The common-electrode-configuration triboelectric generator includes m electrode layers and n high molecular polymer insulating layers, wherein m is greater than or equal to 3, n is greater than or equal to 4, and 2m−n is equal to 2; one electrode layer and two high molecular polymer insulating layers are alternately and sequentially laminated, one or more of the m electrode layers are porous electrode layers, and the porous electrode layers and the high molecular polymer insulating layers laminated thereon are mutually embedded to form an embedded body, and the embedded body is the triboelectric generator electrode; the high molecular polymer insulating layers of every two adjacent triboelectric generator electrodes generate mutual friction to form a friction interface; and every two adjacent electrode layers in the common-electrode-configuration triboelectric generator constitute a group of output terminals of the common-electrode-configuration triboelectric generator.

The common-electrode-configuration triboelectric generator as shown in FIG. 5b is of a seven-layer structure, which includes 3 electrode layers: a first electrode layer 321, a second electrode layer 324 and a third electrode layer 327, and 4 high molecular polymer insulating layers: a first high molecular polymer insulating layer 322, a second high molecular polymer insulating layer 323, a third high molecular polymer insulating layer 325 and a fourth high molecular polymer insulating layer 326. One electrode layer and two high molecular polymer insulating layers are alternately and sequentially laminated, that is, the first electrode layer 321, the first high molecular polymer insulating layer 322, the second high molecular polymer insulating layer 323, the second electrode layer 324, the third high molecular polymer insulating layer 325, the fourth high molecular polymer insulating layer 326 and the third electrode layer 327 are sequentially laminated. Specifically, the first electrode layer 321, the second electrode layer 324 and the third electrode layer 327 are all porous electrode layers, the first electrode layer 321 is mutually embedded with the first high molecular polymer insulating layer 322 laminated on the upper surface thereof to form an embedded body, that is, a triboelectric generator electrode A; the second electrode layer 324 is mutually embedded with the third high molecular polymer insulating layer 325 and the second high molecular polymer insulating layer 323, which are laminated on the upper and lower surfaces thereof, to form an embedded body, that is, a triboelectric generator electrode B; and the third electrode layer 327 is mutually embedded with the fourth high molecular polymer insulating layer 326 laminated on the lower surface thereof to form an embedded body, that is, a triboelectric generator electrode C. The high molecular polymer insulating layers of every two adjacent triboelectric generator electrodes generate mutual friction to constitute the friction interface, for example, the first high molecular polymer insulating layer 322 of the triboelectric generator electrode A and the second high molecular polymer insulating layer 323 of the triboelectric generator electrode B generate mutual friction to constitute a friction interface, and the third high molecular polymer insulating layer 325 of the triboelectric generator electrode B and the fourth high molecular polymer insulating layer 326 of the triboelectric generator electrode C generate mutual friction to constitute a friction interface. Every two adjacent electrode layers constitute a group of output terminals of the common-electrode-configuration triboelectric generator, that is, the first electrode layer 321 and the second electrode layer 324, and the second electrode layer 324 and the third electrode layer 327 form two groups of output terminals. Optionally, a protrusion structure is arranged on at least one of the two surfaces constituting the friction interface, that is, the protrusion structure is arranged on at least one of the two surfaces that generate mutual contact friction, namely the first high molecular polymer insulating layer 322 and the second high molecular polymer insulating layer 323, and the third high molecular polymer insulating layer 325 and the fourth high molecular polymer insulating layer 326.

According to the light emitting shoe provided by the present invention, the external force acting on the sole during walking is converted by the triboelectric power generation module into electric energy, which is then converted by the rectifier circuit module to provide electric energy for the display module on the light emitting shoe, so that the display module emits light. According to the light emitting shoe provided by the present invention, the mechanical energy during walking of a human body is reasonably utilized by the triboelectric power generation module, thereby omitting the use of the battery, which avoids the inconvenience that the light emitting shoe cannot emit light after the energy of the battery is used up and then the battery has to be replaced; furthermore, as the use of the battery is avoided, the energy is saved, and the environment is protected; and meanwhile light emitting shoe provided by the present invention is simple in structure and manufacturing process, low in cost, and suitable for large-scale industrialized production.

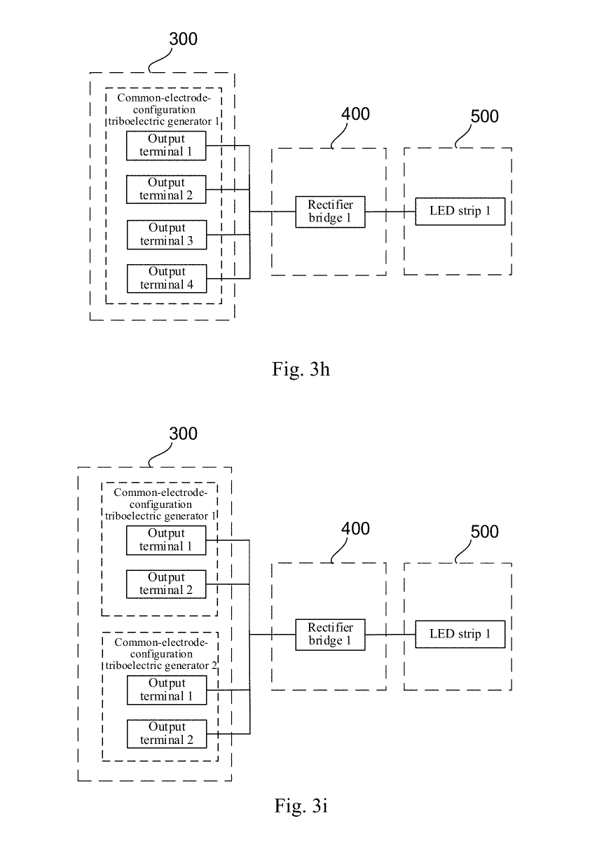

In addition to the modules in the above-mentioned embodiments, the light emitting shoe can further include an energy storage module. FIG. 6 is a circuit structure diagram of an embodiment modules of the light emitting shoe provided by the present invention, the energy storage module 600 is connected with the rectifier circuit module 400 and the display module 500, the rectifier circuit module 400 can convert the alternating current generated by the triboelectric power generation module 300 into direct current, and the direct current is stored by the energy storage module 600, so that the electric energy generated by the triboelectric power generation module 300 can be utilized more efficiently. The energy storage module 600 can be an energy storage element and can be selected from various energy storage elements such as a lithium battery, a nickel-metal hydride battery, a super capacitor, etc.

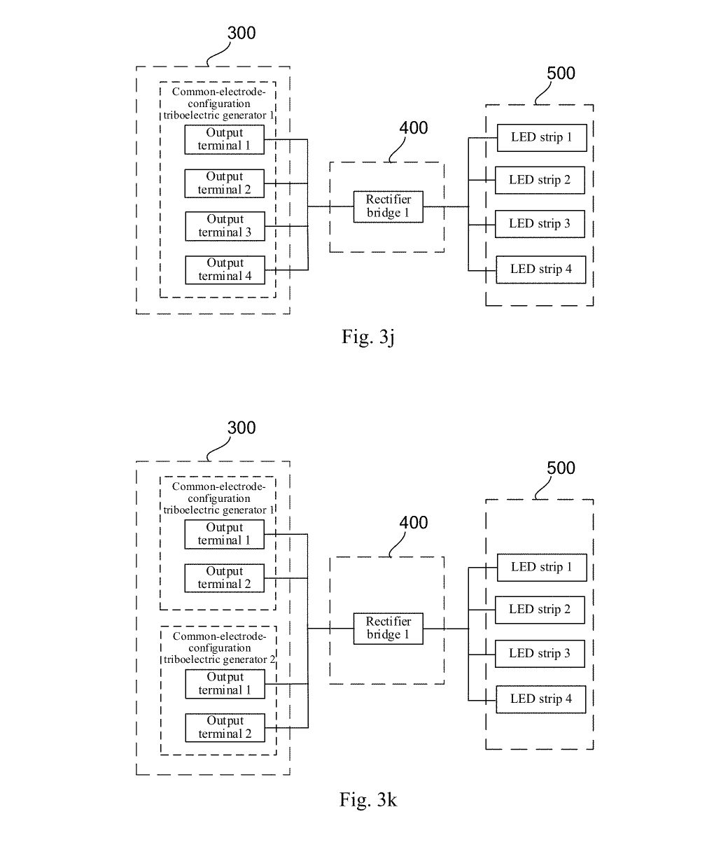

Although the circuit structure shown in FIG. 6 can achieve the continuous lighting effect of the display module within a period of time, and the flickering phenomenon is avoided, however, in the circuit structure shown in FIG. 6, the light emission cannot be controlled, for example, if the user does not want the light emitting shoe to emit light for illumination in some formal occasions during the daytime, the display module cannot be automatically turned off, and as long as the user walks, the light emitting shoe emits light, thereby bringing inconvenience for the user. In order to solve the above problem, the light emitting shoe further includes a control switch module, and as shown in FIG. 7, the control switch module 700 is connected between the energy storage module 600 and the display module 500 for controlling the supply of the electric energy. The control switch module can be a spring switch, a button switch, a vibration switch or a voice controlled switch or other switch.

The light emitting shoe provided by the present invention is provided with the energy storage module and the control switch module to store the electric energy generated by the triboelectric power generation module, so that the light emission of the light emitting shoe can also be achieved by the electric energy stored in the energy storage module when the user does not walk, thereby satisfying the lighting demand (for example, observing the road condition) of the user in a stationary state. Meanwhile, the control switch module can control the on-off of the light emission of the shoe body, so that the light emission of the shoe body can be turned off when the user does not want the shoe body to emit light. Therefore, various needs of the user are satisfied, and great convenience is provided for the user.

The various modules and circuits mentioned in the present invention are all circuits implemented by hardware. Although some of the modules and circuits are integrated with software, what is to be protected by the present invention is the hardware circuits into which the functions of the software are integrated, not just the software itself.

Those skilled in the art should understand that the device structures shown in the drawings or the embodiments are merely schematic and represent logical structures. The modules shown as separate components may be or may be not physically separated, and the components shown as modules may be or may be not physical modules.

Those skilled in the art may understand that although the steps of the method are described in sequence for the convenience of understanding in the above description, it should be noted that the sequence of the above steps is not strictly limited.

Those of ordinary skill in the art may understand that all or part of the steps in the methods in the foregoing embodiments may be implemented by a program instructing relevant hardware, and the program may be stored in a computer readable storage medium, such as an ROM/RAM, a magnetic disk, an optical disk or the like.

Obviously, those skilled in the art can make various modifications and variations to the present invention without departing from the spirit and scope of the present invention. As such, if these modifications and variations of the present invention fall within the scope of the claims of the present invention and the equivalent technologies thereof, the present invention is also intended to include these modifications and variations.

1. A triboelectric generator electrode, comprising a porous electrode layer and a high molecular polymer insulating layer, wherein the porous electrode layer and the high molecular polymer insulating layer are mutually embedded to form an embedded body.

2. The triboelectric generator electrode of claim 1, wherein a part of the porous electrode layer and a part of the high molecular polymer insulating layer are mutually embedded to form a partially embedded body.

3. The triboelectric generator electrode of claim 1, wherein all of the porous electrode layer and all of the high molecular polymer insulating layer are mutually embedded to form a completely embedded body.

4. The triboelectric generator electrode of claim 1, wherein the porous electrode layer is a porous metal or a composite porous body thereof.

5. The triboelectric generator electrode of claim 1, wherein the porous electrode layer is at least one of nickel foam, copper foam, aluminum foam, porous iron, porous copper or a composite porous body thereof.

6. A manufacturing method of the triboelectric generator electrode, the method comprises the following steps:
(1) brushing a first high molecular polymer insulating coating on the surface of a template having a microstructure, and carrying out a degassing treatment;
(2) cutting a porous electrode layer with a smooth surface into a target size;
(3) fitting the porous electrode layer to the surface of the first high molecular polymer insulating coating, and carrying out a curing treatment; and
(4) taking a first high molecular polymer insulating coating/porous electrode layer composite film from the surface of the template.

7. The manufacturing method of the triboelectric generator electrode of claim 6, wherein, in the step (2), the porous electrode layer is flattened, so that its thickness reaches a target thickness.

8. The manufacturing method of the triboelectric generator electrode of claim 6, wherein the first high molecular polymer insulating coating in the step (3) is a high molecular polymer insulating coating subjected to a curing treatment, and preferably before the porous electrode layer is fitted, a second high molecular polymer insulating coating is brushed on the surface of the cured first high molecular polymer insulating coating.

9. The manufacturing method of the triboelectric generator electrode of claim 8, wherein the method further comprises step (5) after the step (3): brushing a third high molecular polymer insulating coating on the surface of the porous electrode layer, and performing degassing and curing treatments.

10. The manufacturing method of the triboelectric generator electrode of claim 6, wherein the first high molecular polymer insulating coating in the step (3) is a high molecular polymer insulating coating subjected to a semi-curing treatment.

11. The manufacturing method of the triboelectric generator electrode of claim 10, wherein the method further comprises step (6) after the step (3): brushing a second high molecular polymer insulating coating on the surface of the porous electrode layer, and performing degassing and curing treatments.

12. The manufacturing method of the triboelectric generator electrode of claim 6, wherein the first high molecular polymer insulating coating in the step (3) is a high molecular polymer insulating coating subjected to no curing treatment, and preferably standing is performed for 1-10 min after the porous electrode layer is fitted to the surface of the first high molecular polymer insulating coating.

13. A light emitting shoe, comprising a sole and a vamp, wherein the light emitting shoe further comprises: a triboelectric power generation module, a rectifier circuit module and a display module; wherein the triboelectric power generation module and the rectifier circuit module are located at the sole, and the display module is located on the sole and/or the vamp;
the triboelectric power generation module comprises at least one triboelectric generator for converting mechanical energy into electric energy; wherein the triboelectric generator comprises the triboelectric generator electrode of claim 1;
the rectifier circuit module comprises at least one rectifier bridge connected with the triboelectric power generation module and used for rectifying the electric energy output by the triboelectric power generation module; and
the display module is connected with the rectifier circuit module and is used for receiving the electric energy output by the rectifier circuit module to achieve light emitting display of the display module.

14. The light emitting shoe of claim 13, wherein the triboelectric generator is a common-electrode-configuration triboelectric generator, and the display module is a single or a plurality of LED strips.

15. The light emitting shoe of claim 14, wherein the common-electrode-configuration triboelectric generator comprises m electrode layers and n high molecular polymer insulating layers, wherein m is greater than or equal to 3, n is greater than or equal to 2, and m−n is equal to 1;
one or more of the m electrode layers are porous electrode layers, and the porous electrode layers and the high molecular polymer insulating layers laminated thereon are mutually embedded to form an embedded body, and the embedded body is the triboelectric generator electrode;
the high molecular polymer insulating layers of the triboelectric generator electrode generate mutual friction with other electrode layers of the m electrode layers to form a friction interface; and
every two adjacent electrode layers in the common-electrode-configuration triboelectric generator constitute a group of output terminals of the common-electrode-configuration triboelectric generator.

16. The light emitting shoe of claim 14, wherein the common-electrode-configuration triboelectric generator comprises m electrode layers and n high molecular polymer insulating layers, wherein m is greater than or equal to 3, n is greater than or equal to 4, and 2m−n is equal to 2;
one or more of the m electrode layers are porous electrode layers, and the porous electrode layers and the high molecular polymer insulating layers laminated thereon are mutually embedded to form an embedded body, and the embedded body is the triboelectric generator electrode;
the high molecular polymer insulating layers of every two adjacent triboelectric generator electrodes generate mutual friction to form a friction interface; and
every two adjacent electrode layers in the common-electrode-configuration triboelectric generator constitute a group of output terminals of the common-electrode-configuration triboelectric generator.

17. The light emitting shoe of claim 15, wherein a protrusion structure is arranged on at least one of the two surfaces constituting the friction interface.

18. The light emitting shoe of claim 15, wherein multiple groups of output terminals of the common-electrode-configuration triboelectric generator are connected with a plurality of the rectifier bridge(s) in a one-to-one correspondence manner respectively.

19. The light emitting shoe of claim 15, wherein multiple groups of output terminals of the common-electrode-configuration triboelectric generator are connected with a plurality of the rectifier bridge(s), and the output terminals of the common-electrode-configuration triboelectric generator connected with one of the rectifier bridge(s) are connected in series and/or in parallel.

20. The light emitting shoe of claim 15, wherein multiple groups of output terminals of the common-electrode-configuration triboelectric generator are connected with one of the rectifier bridge(s), and the output terminals of the common-electrode-configuration triboelectric generator connected with the one rectifier bridge are connected in series and/or in parallel.

21. The light emitting shoe of claim 18, wherein the single LED strip is connected with a plurality of the rectifier bridge(s); or
a plurality of the LED strips are respectively connected with a plurality of the rectifier bridges in a one-to-one correspondence manner; or
a plurality of the LED strips are connected with a plurality of the rectifier bridges in series and/or in parallel.

22. The light emitting shoe of claim 20, wherein the single LED strip is connected with one of the rectifier bridge(s); or
the plurality of LED strips are connected with one of the rectifier bridge(s) in series and/or in parallel.

23. The light emitting shoe of claim 13, wherein the sole further comprises a bottom surface and a side face, and the display module is arranged on the side face of the sole.

24. The light emitting shoe of claim 13, wherein the vamp comprises a surface layer and an inner layer, and the display module is arranged between the surface layer and the inner layer.

25. The light emitting shoe of claim 13, wherein the LED strips can be arranged in a preset shape; and the preset shape comprises a Chinese character shape, a Pinyin shape or a logo shape of the light emitting shoe.

26. The light emitting shoe of claim 13, wherein the light emitting shoe further comprises an energy storage module; and the energy storage module is connected with the rectifier circuit module and the display module.

27. The light emitting shoe of claim 13, wherein the light emitting shoe further comprises a control switch module connected between the energy storage module and the display module, and the control switch module is a spring switch, a button switch, a vibration switch or a voice controlled switch.

28. The light emitting shoe of claim 13, wherein a plurality of the triboelectric generators are arranged inside the sole in a laminated or tiled manner.
